(19) United States
(12) Patent Application Publication
(10) Pub. No.: US 2006/0164665 A1
(43) Pub. Date: Jul. 27, 2006

(54) Method and apparatus for to generate a character image

(76) Inventor: Yong-jo Park, Suwon-si (KR)

Correspondence Address: STANZIONE & KIM, LLP, 919 18TH STREET, N.W., SUITE 440, WASHINGTON, DC, 20006, US

(21) Appl. No.: 11/330,072

(22) Filed: Jan. 12, 2006

(30) Foreign Application Priority Data
Jan. 24, 2005 (KR) 2005-6352

(51) Int. Cl. G06K 15/02

(52) U.S. Cl. 358/1.11

(57) ABSTRACT

An apparatus to generate a character image includes a character image generating unit to generate a character image from a scalable font according to information for generating the character image from the scalable font, a generation frequency list storing unit to store the number of times that the scalable font has been generated as the character image by the character image generating unit, a scalable font converting unit to convert the scalable font into a bitmap font, when the number of times stored in the generation frequency list exceeds a predetermined limit number of times, and a converted font storing unit to store the bitmap font converted by the scalable font converting unit. Accordingly, the scalable font is generated as the character image according to a method of processing a character print command using a bitmap font without mathematical processing to provide a font of a high print quality.

### CROSS-REFERENCE TO RELATED APPLICATIONS

This application claims priority under 35 U.S.C. § 119 from Korean Patent Application No. 2005-6352, filed on Jan. 24, 2005, in the Korean Intellectual Property Office, the disclosure of which is incorporated herein in its entirety by reference.

### BACKGROUND OF THE INVENTION

1. Field of the Invention

The present general inventive concept relates to an apparatus to print characters, such as a printer or a fax machine, and more particularly, to a method and apparatus to generate a character image.

2. Description of the Related Art

A scalable font is generated as a character image by drawing a font outline according to vector information of the font and filling an inside of the font outline using a filling algorithm.

FIG. 1 is a block diagram of a conventional apparatus for generating a character image. The conventional apparatus includes an emulation unit 100, a font control unit 110, a resident font storing unit 130, and a character image generating unit 140.

Upon receiving a print command, the emulation unit 100 transmits information about a font and a character code, which is necessary to print an image, to the font controlling unit 110 to generate the character image. The font control unit 110 controls the emulation unit 100, the resident font storing unit 130 and the character image generating unit 140 to generate the character image. The resident font storing unit 130, such as a Font Mask ROM, stores information for generating a character image corresponding to one of a bitmap font and a scalable font. When the scalable font is requested, the character image generating unit 140 generates the character image corresponding to a character code of the scalable font using a vector processing method and then transmits the character image to the emulation unit 100.

Referring to FIG. 1, when character image data of the bitmap font, which has been conventionally used, is output, a font size is fixed, and when the font size is adjusted using scaling, a stair-step effect occurs in the character image and the print quality is worse than when using the scalable font. Meanwhile, when character image data of the scalable font is output, vector information of the scalable font is read from the Font Mask ROM to create an outline of the font whenever the character image data is output and the inside of the outline is filled using a filling algorithm to generate the character image. Therefore, it takes a relative longer period of time to execute the character print command.

### SUMMARY OF THE INVENTION

The present general inventive concept provides a method and apparatus to generate a character image, in which a scalable font that is frequently generated is converted into a bitmap font and stored in an internal storage device in order to enhance a print quality and reduce a printing time.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an apparatus to generate a character image, comprising a character image generating unit to generate a character image from a scalable font according to information for generating the character image from the scalable font, a generation frequency list storing unit which stores the number of times that the scalable font has been generated as the character image by the character image generating unit in a generation frequency list, a scalable font converting unit to convert the scalable font into a bitmap font, when the number of times that the scalable font has been generated as the character image that is stored in the generation frequency list exceeds a predetermined limit number of times, and a converted font storing unit to store the bitmap font converted from the scalable font by the scalable font converting unit.

The apparatus may further comprise a scalable font storing unit to store the information for generating the character image from the scalable font, and a font retrieving unit to search whether a requested font is stored in the converted font storing unit, to read the character image from the converted font storing unit, to search whether the requested font is stored in the scalable font storing unit, and to receive the character image from the character image generating unit when the requested font is not stored in the converted font storing unit.

the scalable font converting unit may convert the scalable font into the bitmap font, when the number of times stored in the generation frequency list exceeds the predetermined limit number of times and when a print device is in a standby state.

The scalable font converting unit may increase the predetermined limit number of times that the scalable font has been generated as the character image at a regular rate when an available capacity of the converted font storing unit is exceeded.

The converted font storing unit may delete the bitmap font that is generated the least number of times and stores the bitmap font that is converted by the scalable font converting unit when an available capacity of the converted font storing unit is exceeded.

The foregoing and/or other aspects of the present general inventive concept may also be achieved by providing a method of generating a character image, comprising generating a character image from a scalable font according to information for generating the character image from the scalable font, storing the number of times that the scalable font has been generated as the character image, converting the scalable font into a bitmap font, when the stored number of times that the scalable font has been generated as the character image exceeds a predetermined limit number of times, and storing the bitmap font.

The method may further comprise storing information for generating the character image from the scalable font, and searching whether a requested font is stored as the bitmap font and reading the bitmap font as the character image if the requested font is stored as the bitmap font, and receiving the character image generated from the scalable font according to the information for generating the scalable font if the requested font is not stored as the bitmap font.

The converting of the scalable font may comprise converting the scalable font into the bitmap font of which the stored number of times that has been generated as the character image exceeds the predetermined limit number of times may be converted into the bitmap font when a print device is in a standby state in which a printing operation is not performed.

The converting of the scalable font may comprise increasing the predetermined limit number of times at a regular rate, when an available storing capacity of the converted bitmap font is exceeded.

The storing the converted bitmap font may comprise deleting a font that is generated the least number of times, when an available capacity is exceeded, and storing the converted bitmap font.

The foregoing and/or other aspects of the present general inventive concept may also be achieved by providing an apparatus to generate a character image, comprising a scalable font storing unit to store one or more scalable fonts, a converted font storing unit to store one or more bitmap fonts converted from respective ones of the one or more scalable fonts, and a conversion font generating unit to convert the one or more scalable fonts into the corresponding one or more bitmap fonts according to the number of times in which each of the one or more scalable fonts is read from the scalable font storing unit to generate the character image.

The foregoing and/or other aspects of the present general inventive concept may also be achieved by providing a computer readable medium containing executable code of a method of generating a character image, the executable codes comprising a first executable code to store and retrieve one or more scalable fonts, a second executable code to store and retrieve one or more bitmap fonts converted from respective ones of the one or more scalable fonts, and a third executable code to convert the one or more scalable fonts into the corresponding one or more bitmap fonts according to the number of times in which each of the one or more scalable fonts is read from the scalable font storing unit to generate the character image.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional apparatus for generating a character image;

FIG. 2 is a block diagram illustrating an apparatus to generate a character image according to an embodiment of the present general inventive concept;

FIG. 3 is a flowchart illustrating a method of generating a character image according to an embodiment of the present general inventive concept; and

FIG. 4 is a flowchart illustrating a method of generating a character image according to another embodiment of the present general inventive concept.

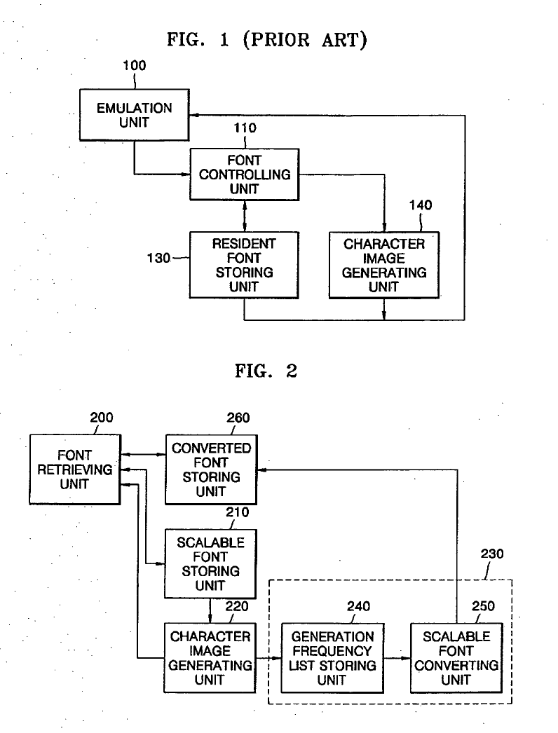

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram of an apparatus to generate a character image according to an embodiment of the present general inventive concept. The apparatus to generate the character image includes a font retrieving unit 200, a scalable font storing unit 210, a character image generating unit 220, a conversion font generating unit 230, and a converted font storing unit 260. The conversion font generating unit 230 includes a generation frequency list storing unit 240 and a scalable font converting unit 250.

The scalable font storing unit 210, such as a Font Mask ROM, that may be built in an image forming apparatus, for example, a print device, stores information for generating the character image from a scalable font.

Attributes of the scalable font include a font size, a bold, a rotation angle, and the like.

The character image generating unit 220 generates the character image from the scalable font using the information for generating the character image stored in the scalable font storing unit 210.

The conversion font generating unit 230 converts the scalable font that is frequently generated into a bitmap format, that is, converts the scalable font in a bitmap font.

Each time when the character image generating unit 220 generates the character image from the scalable font, the generation frequency list storing unit 240 updates the number of times that each of scalable fonts has been generated as the character image and stores the number of times.

The scalable font converting unit 250 examines the number of times that each scalable font has been generated as the character image, which is stored in the generation frequency list storing unit 240, and when the number of times exceeds a predetermined limit number of times, the scalable font converting unit 250 converts a specific scalable font into a corresponding bitmap font. The corresponding bitmap font is then stored in the converted font storing unit 260. Further, the scalable font converting unit 250 may increase the predetermined limit number of times at a regular rate when the bitmap fonts exceed an available capacity of the converted font storing unit 260.

The number of times that the scalable font is generated as the character image may be examined every time when the character image generating unit 220 generates the character image from the scalable font, periodically at a predetermined time interval set in the print device, or during a standby period when the print device does not work.

The converted font storing unit 260 stores the bitmap font converted from the scalable font by the scalable font converting unit 250. Further, when the bitmap fonts exceed an available storage capacity of the converted font storing unit 260, the converted font storing unit 260 deletes a bitmap font corresponding to the scalable font that is generated the least number of times. The converted font storing unit 260 may be an internal storage device, such as a flash memory or a hard disk HDD.

When a printing operation is requested, the font retrieving unit 200 searches whether a requested font necessary for printing is present in the converted font storing unit 260, and, if present, reads a character image of the requested font. When the requested font is not present in the converted font storing unit 260, the font retrieving unit 200 searches whether the requested font is present in the scalable font storing unit 210 and receives the character image from the character image generating unit 220.

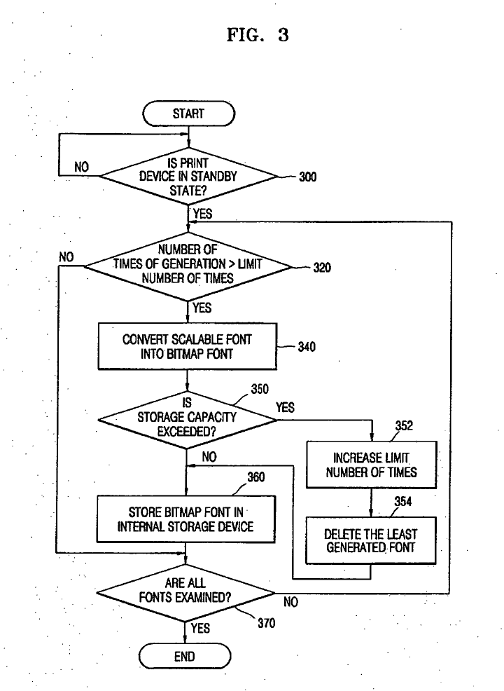

FIG. 3 is a flowchart illustrating a method of generating a character image according to an embodiment of the present general inventive concept.

A print device in which printing operations are not executed yet is monitored whether the print device is in a standby state in operation 300.

If, it is determined that the print device is in the standby state, in a generation frequency list that stores the number of times that each scalable font has been generated as a character image using a vector processing method, it is checked if the number of times exceeds a predetermined limit number of times set in the print device in operation 320.

If the number of times is less than the predetermined limit number of times, operation 370 is executed to determine whether all fonts stored in the generation frequency list have been examined.

If the number of times that a specific scalable font has been generated exceeds the predetermined limit number of times, the specific scalable font is converted into a bitmap font in operation 340.

Then, in operation 350, it is examined whether a capacity of an internal storage device that stores the bitmap font converted from the scalable font in operation 340 is exceeded.

When the capacity of the internal storage device is exceeded, the predetermined limit number of times that is used in the operation 320 is increased at a regular rate in operation 352.

After operation 352, the bitmap font converted from the scalable font that is generated the least number of times is deleted from the internal storage device in operation 354.

Information about the scalable font converted in operation 340 and the bitmap font converted from the scalable font are stored in an internal storage device, such as a flash memory or a hard disk in operation 360.

In the operation 370, it is determined whether all scalable fonts stored in the generation frequency list have been examined.

If it is determined that all the scalable fonts stored in the generation frequency list are not examined, the procedure turns to the operation 320 to examine whether the number of times that each scalable font has been generated exceeds the predetermined limit number of times.

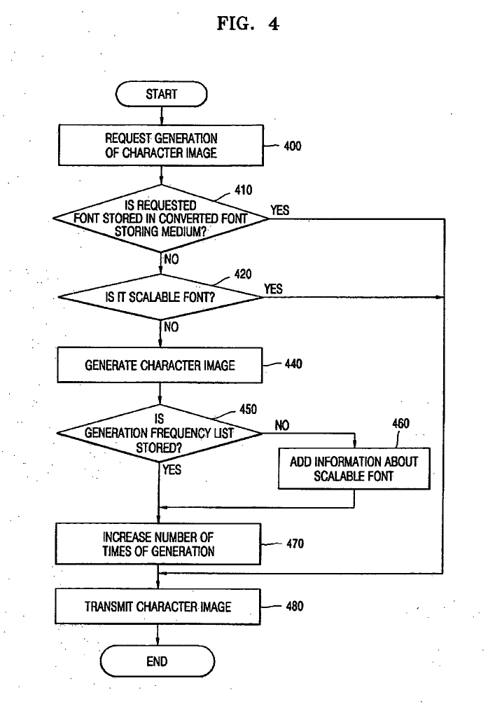

FIG. 4 is a flowchart illustrating a method of generating a character image according to another embodiment of the present general inventive concept.

When a print command is input to an emulation unit, the emulation unit requests generation of character images in operation 400.

In operation 410, it is searched whether a font requested in operation 400 is stored in a converted font storing medium, such as a flash memory or a hard disk, that stores a bitmap font converted from a scalable font.

If it is determined that the requested font is stored in the converted font storing medium, a character image corresponding to attributes of the requested font and a character code are read from the converted font storing medium and transmitted to the emulation unit.

Alternatively, if it is determined that the requested font is not stored in the converted font storing medium, in operation 420, it is searched if the requested font is stored in a scalable font storing medium, such as a Font Mask ROM, that is built in an image forming apparatus, for example, a print device, and stores information for generating the character image from the scalable font.

If it is determined that the requested font is a bitmap font, the corresponding bitmap font is read from an internal storage device storing bitmap fonts and transmitted to the emulation unit.

When, in operation 420, it is determined that the requested font is a scalable font, in operation 440, a character image corresponding to a character code of the scalable font requested from the emulation unit is generated using a vector processing method.

Then, in operation 450 it is examined whether the scalable font generated as the character image in operation 440 is stored in a generation frequency list which stores the numbers of times that each scalable font has been generated.

If information about the scalable font generated as the character image is not stored in the generation frequency list, the information about the scalable font is added to the generation frequency list in operation 460.

If the information about the scalable font is stored in the generation frequency list, the number of times that the scalable font has been generated is increased by one and stored in the generation frequency list in operation 470.

The generated character image is then transmitted to the emulation unit in operation 480.

According to the present embodiment, in a method and apparatus to generate a character image, a scalable font that is frequently generated is converted into a bitmap font having a bitmap format and stored in an internal storage device.

Generally, users tend to repeatedly use a certain font. For example, a Courier 10 character per inch (CPI) font or an Arial 12-point font is relatively frequently used for printing documents. A scalable font of a specific size among frequently generated scalable fonts is converted into a bitmap font and stored, and accordingly, a character image can be generated from the scalable font according to a method of processing a character print command of a bitmap font without mathematical processing. Therefore, the time for vector processing a scalable font to generate the character image is reduced, and thus, a character print command can be promptly performed.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the conversion font generating unit may be embodied in software, hardware, or a combination thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to generate a character image, comprising:
a character image generating unit to generate a character image from a scalable font according to information for generating the character image from the scalable font;
a generation frequency list storing unit to store the number of times that the scalable font has been generated as the character image by the character image generating unit in a generation frequency list;
a scalable font converting unit to convert the scalable font into a bitmap font, when the number of times stored in the generation frequency list exceeds a predetermined limit number of times; and
a converted font storing unit to store the bitmap font converted from the scalable font by the scalable font converting unit.

2. The apparatus of claim 1, further comprising:
a scalable font storing unit to store the information for generating the character image from the scalable font; and
a font retrieving unit to search whether a requested font is stored in the converted font storing unit, to read the bitmap font as the character image from the converted font storing unit when the requested font is stored in the converted font storing unit, to search whether information for generating the character image from the requested font is stored in the scalable font storing unit, and to receive the character image from the character image generating unit when the received font is not stored in the converted font storing unit.

3. The apparatus of claim 1, wherein the scalable font converting unit converts the scalable font into the bitmap font, when the number of times stored in the generation frequency list exceeds the predetermined limit number of times, and when a print device is in a standby state.

4. The apparatus of claim 1, wherein the scalable font converting unit increases the predetermined limit number of times that the scalable font has been generated as the character image at a regular rate when an available capacity of the converted font storing unit is exceeded.

5. The apparatus of claim 1, wherein the converted font storing unit deletes the bitmap font that is generated the least number of times and stores the bitmap font that is converted by the scalable font converting unit, when an available capacity of the converted font storing unit is exceeded.

6. A method of generating a character image, comprising:
generating a character image from a scalable font according to information for generating the character image from the scalable font;
storing the number of times that the scalable font has been generated as the character image;
converting the scalable font into a bitmap font, when the stored number of times that the scalable font has been generated as the character image exceeds a predetermined limit number of times; and
storing the converted bitmap font.

7. The method of claim 6, further comprising:
storing the information for generating the character image from the scalable font; and
searching whether a requested font is stored as the bitmap font converted from the scalable font;
reading a character image if the requested font is stored as the bitmap font;
searching the requested font is stored if the received font is not stored as the bitmap font, and receiving the character image generated from the scalable font according to the information for generating the scalable font.

8. The method of claim 6, wherein the converting of the scalable font comprises converting into the bitmap font the scalable font of which the stored number of times that has been generated as the character image the number of times exceeds the predetermined limit number of times is converted into the bitmap font when a print device is in a standby state in which a printing operation is not performed.

9. The method of claim 6, wherein the converting of the scalable font comprises increasing the limit number of times at a regular rate when an available capacity of storing the converted bitmap font is exceeded.

10. The method of claim 9, wherein the storing the converted bitmap font comprises deleting a font that is generated the least number of times and storing the converted bitmap font.

11. An apparatus to generate a character image, comprising:
a scalable font storing unit to store one or more scalable fonts;
a converted font storing unit to store one or more bitmap fonts converted from respective ones of the one or more scalable fonts; and
a conversion font generating unit to convert the one or more scalable fonts into the corresponding one or more bitmap fonts according to the number of times in which each of the one or more scalable fonts is read from the scalable font storing unit to generate the character image.

12. The apparatus of claim 11, further comprising:
a font retrieving unit to read and output one of the one or more bitmap fonts corresponding to a requested character image when the bitmap font corresponding to the requested character image is stored in the converted font storing unit, and to read and output one of the one or more scalable fonts to provide the requested character image when the bitmap font corresponding to the requested character image is not stored in the converted font storing unit.

13. The apparatus of claim 12, wherein when the one of the one or more scalable fonts is read, the read scalable font is scaled.

14. The apparatus of claim 12, wherein if the bitmap font corresponding to the requested character image is read from the converted font storing unit, the bitmap font is not scaled.

15. The apparatus of claim 11, wherein the conversion font generating unit converts the one or more scalable fonts into the corresponding one or more bitmap fonts when the number of times in which each of the one or more scalable fonts is read from the scalable font storing unit to generate the character image exceeds a predetermined limit number.

16. The apparatus of claim 15, wherein the predetermined limit number varies according to a comparison between a storage capacity of the converted font storing unit and an amount of the one or more bitmap fonts stored in the converted font storing unit.

17. The apparatus of claim 11, wherein the bitmap font corresponding to the least number of times is deleted from the converted font storing unit according to a comparison between a storage capacity of the converted font storing unit and an amount of the one or more bitmap fonts.

18. The apparatus of claim 11, further comprising:
a character image generating unit to generate the character image from the one or more scalable fonts stored in the scalable font storing unit when the bitmap font corresponding to the requested character image is not stored in the converted font storing unit.

19. The apparatus of claim 11, wherein the one or more scalable fonts comprises first and second scalable fonts having a first number of times and a second number of times, respectively, and the conversion font generating unit selectively converts the first and second scalable fonts according to a comparison between a reference number and the first and second number of times.

20. A computer readable medium containing executable codes of a method of generating a character image, the executable codes comprising:
a first executable code to store and retrieve one or more scalable fonts;
a second executable code to store and retrieve one or more bitmap fonts converted from respective ones of the one or more scalable fonts; and
a third executable code to convert the one or more scalable fonts into the corresponding one or more bitmap fonts according to the number of times in which each of the one or more scalable fonts is read from the scalable font storing unit to generate the character image.
